(19) United States
(12) Patent Application Publication
(10) Pub. No.: US 2008/0300809 A1
(43) Pub. Date: Dec. 4, 2008

(54) Defect inspecting method and device thereof

(75) Inventors: Hsuan Yang, Taoyuan (TW); Shia-Chih Lai, Taoyuan (TW); Jia-Lin Shen, Taoyuan (TW)

Correspondence Address: Haverstock & Owens L.L.P., 162 North Wolfe Road, Sunnyvale, CA, 94086, US

(73) Assignee: Delta Electronics, Inc.

(21) Appl. No.: 11/906,606

(22) Filed: Oct. 2, 2007

(30) Foreign Application Priority Data
Jun. 4, 2007 (TW) 96120025

(51) Int. Cl. G06F 19/00

(52) U.S. Cl. 702/81

(57) ABSTRACT

A defect inspecting method is provided. The defect inspecting method for inspecting a defect information of a target device includes steps of retrieving one of a whole image and a part of image of the target device; setting a plurality of conditions for a defect recognizing scheme; adjusting the plurality of conditions by a manual scheme; adjusting the plurality of conditions based on the retrieved image; and implementing the defect recognizing scheme based on the adjusted plurality of conditions for inspecting the target device, so as to obtain the defect information of the target device is provided.

### FIELD OF THE INVENTION

The present invention relates to a defect inspecting method and device, in particular, to a defect inspecting method and device for controlling the quality of product.

### BACKGROUND OF THE INVENTION

Currently, as the market of consumer electronics prosperously grows, the consumer period becomes shorter. Therefore, for a professional electronic manufacturer, a high-speed productivity with excellent quality is always a critical issue to take the lead in this competitive market nowadays. In this respect, how to fast and precisely inspect a finished electronic product or a semifinished electronic product thus becomes important and various image-inspecting schemes for inspecting the electronic goods is generally developed with the tide of fashion.

In all of these inspecting schemes, the scheme based on retrieving the image of device under test (DUT) is the most popular one to be widely applied to the production line, so as to recognize the defects existing in DUT and to weed out the defective goods before shipment. For instance, the scheme is used to inspect whether the labels are reliably adhered on the goods, or whether the respective finished Liquid Crystal Display(s) (LCD) are the defected one or not. The utilization of the image-inspecting scheme is not only able to save labors, but also to increase the reliability and speed to entire manufacturing processes, and furthermore to provide the statistic data with respect to the defects for accurately analyzing the production line and for improving the manufacturing flow. Besides, when the DUT becomes smaller which results in invisible, the image-inspecting scheme would more depend on to pick out the defected goods.

In terms of the prior art, in the beginning, one provides the defect inspecting apparatus with a standard goods, and then the defect inspecting apparatus could automatically set up the parameters based on the features of the standard goods. Conventionally, the processes for automatically setting up the parameters is quite sophisticated, even though a technician from the original factory in which the defect inspecting apparatus is fabricated is necessitated for tuning or regulating the parameters, in order to obtain the optimum inspecting results. Furthermore, once the tuning or regulating process is completed, the parameters are subsequently determined as well, so that the predetermined parameters are unable to be further modified or be modified in real time while inspecting performing. Since the rate of inspection relies on the values of parameters, the predetermined parameters as above-mentioned would indirectly limit and affect the inspecting results. Although a part of the inspecting apparatus is equipped with the training capability to tune the parameters, it is merely designed to retrieve some incomplete information, which is impossible to efficiently enhance the rate of inspection.

To briefly sum up, the deficiency of the conventional defect inspecting apparatus is summarized as follows. Once the DUT is changed, it might need the original technician to re-perform the sophisticated retuning or re-regulation to the defect inspecting apparatus, such that the apparatus is then suitable for the next DUT. In this regard, when one has to change the DUT, or has to frequently change the DUT, inconvenience and waste for time and capital would thus occur.

To overcome the mentioned drawbacks of the prior art, a novel defect inspecting method and device thereof is provided.

### SUMMARY OF THE INVENTION

This defect inspecting apparatus and method thereof is proposed by the inventor based on the deep thought. In accordance with the inputted information, the present invention provides a recognizing scheme and device with the self-training mechanism so as to enhance the rate of recognition on the basis of demands from users. First, one can randomly pick up an inspecting region of the DUT (device under test) and select a defect inspecting scheme built in the system. Various parameters and default values are provided by the system according to the different defect inspecting scheme. Then an interactive parameter optimization process is subsequently executed to adjust the parameters during respective training (testing) phase and working phase, which process interacts with users. Since one does not need to know any detail regarding the implementation of parameters, different DUT could thus be frequently changed, such that a more elastic inspection and a more precise rate of inspection are practically achieved. Besides, the present invention could rapidly pick up the DUT with defects before shipment, and thus the labor cost is efficiently cut down.

According to the first aspect of the present invention, a defect inspecting method for inspecting a defect information of a target device including steps of retrieving one of a whole image and a part of image of the target device; setting a plurality of conditions for a defect recognizing scheme; adjusting the plurality of conditions by a manual scheme; adjusting the plurality of conditions based on the retrieved image; and implementing the defect recognizing scheme based on the adjusted plurality of conditions for inspecting the target device, so as to obtain the defect information of the target device is provided.

Preferably, a defect inspecting method further including a step of outputting the adjusted plurality of conditions to a database.

Preferably, the step of setting is accomplished by accessing the plurality of conditions from a database.

Preferably, a defect inspecting method further including a step of outputting the defect information.

Preferably, the defect recognizing scheme is one of a Blob algorithm and a patterning matching algorithm.

Preferably, the plurality of conditions with respect to the Blob algorithm comprise one selected from a group consisting of a binarized boundary value, a brightness contrast and an amount of inspected devices.

Preferably, the plurality of conditions comprise a plurality of numerical parameters.

According to the second aspect of the present invention, a condition adjusting method, for inspecting at least one standard device to obtain a plurality of conditions for a defect recognizing scheme, including steps of retrieving one of a whole image and a part of image of the at least one standard device; adjusting the plurality of conditions based on the retrieved image; and adjusting the plurality of conditions by a manual scheme is provided.

Preferably, a condition adjusting method further including a step of outputting the adjusted plurality of conditions to a database.

According to the third aspect of the present invention, a defect inspecting device inspecting a defect information of a target device, including a image retrieval device obtaining one of a whole image and a part of image of the target device; a calculating device connected with the image retrieval device, for providing a defect recognizing scheme and a plurality of conditions thereof, adjusting the plurality of conditions and inspecting the target device by the defect recognizing scheme based on the plurality of conditions, so that the defect information is obtained; and an output device connected with the calculating device, for outputting the defect information is provided.

Preferably, the plurality of conditions are adjusted by the calculating device based on a manual scheme.

Preferably, the plurality of conditions are adjusted by the calculating device based on the images.

Preferably, the image retrieval device is a CCD.

Preferably, the calculating device is one selected from a group consisting of an inspect circuit, a personal computer and a notebook computer.

Preferably, the output device is one selected from a group consisting of a CRT screen, a panel display and a projector.

Preferably, the defect recognizing scheme is one of a Blob algorithm and a patterning matching algorithm.

Preferably, the plurality of conditions with respect to the Blob algorithm comprise one selected from a group consisting of a binarized boundary value, a brightness contrast and an amount of inspected devices.

Preferably, the plurality of conditions comprise a plurality of numerical parameters.

To sum up, the present invention proposes a defect inspecting method that one can select an inspecting region and DUT, and select a specific recognizing scheme. Then system will automatically determine the necessary parameters. Through respective training and inspecting, the system demonstrates the training and inspecting results and asks users to response the results. Through such interaction, the system will automatically adjust the parameter to be the optimum value, so as to achieve a better rate of inspection and to meet the expectation from users.

The foregoing and other features and advantages of the present invention will be more clearly understood through the following descriptions with reference to the drawings:

### BRIEF DESCRIPTION OF THE DRAWINGS

FIG. 1 is a diagram illustrating a defect inspecting device according to the present invention;

FIG. 2 is a flow chart illustrating the training phase according the defect inspecting method of the present invention;

FIG. 3 is a diagram illustrating the interface of the operation software used during the training phase;

FIG. 4 is a diagram illustrating the interface of the operation software used during the execution of the defect recognizing scheme at the training phase; and

FIG. 5 is a flow chart illustrating the working phase according the defect inspecting method of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the aspect of illustration and description only, it is not intended to be exhaustive or to be limited to the precise form disclosed.

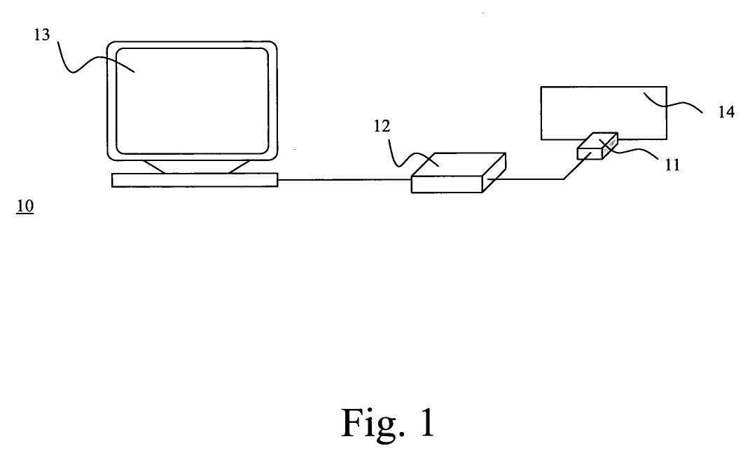

Please refer to FIG. 1, which is a diagram illustrating a defect inspecting device according to the present invention. The defect inspecting device 10 illustrated in FIG. 1 includes an image retrieval device 11, a calculating device 12 and an output device 13, and in FIG. 1, the defect inspecting device 10 further includes a target device 14, wherein the defect inspecting device 10 according to the present invention is used to inspect the defects of the target device 14 (device under test, DUT), the image retrieval device 11 is a CCD, the calculating device 12 is an inspect circuit, a personal computer or a notebook computer, the output device 13 is a CRT screen, a panel display or a projector and the target device 14 is a PCB board whose solders soldering on the backside of the PCB board are going to be inspected to determine whether the quality of the solders comply with the requirements of the quality control or not by the defect inspecting device according to the present invention. The defect inspecting method according to the present invention going to be disclosed is typically based on the above-mentioned defect inspecting device.

The defect inspecting method according to the present invention is introduced as follows. The method could be categorized into two phases, a training (testing) phase and a working phase respectively. The training phase refers to a condition adjusting method used to adjust the necessary parameters for the defect inspecting method that would be executed before the defect inspecting method is actually applied to the productive line for inspecting the target device 14, that is to optimize the necessary inspecting conditions. After the inspecting conditions are optimized, the defect inspecting method enters the working phase that inspects the target device 14 based on the optimized inspecting conditions. Besides, in the defect inspecting method, one is allowed to enter the method at any time depending on the practical circumstance of the productive line, so as to fine tune the inspecting conditions.

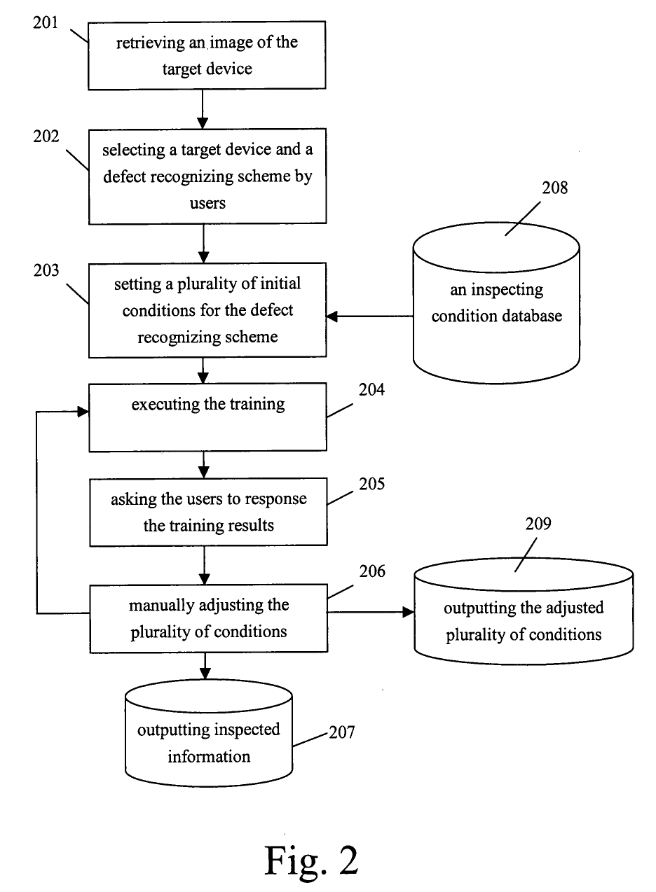

The training (testing) phase is introduced in the beginning. Please refer to FIG. 2, which is a flow chart illustrating the training phase according the defect inspecting method of the present invention. The steps of the FIG. 2 includes steps of retrieving an image of the target device 201, selecting a target device and a defect recognizing scheme by users 202, setting a plurality of initial conditions for the defect recognizing scheme 203, executing the training 204, asking the users to response the training results 205, manually adjusting the plurality of conditions 206, outputting the inspected information 207 and outputting the adjusted plurality of conditions 209, and in FIG. 1, it further includes an inspecting condition database 208. It is noted that during the training phase, the target device, namely a PCB board is not a defected device, which is a standard device whose solder on the backboard is well soldered complying with the requirements of the quality control. The main object of the training phase aims to optimize the parameters via a manner for performing the defect recognizing scheme by giving a standard target device.

While performing the training, a CCD (charge coupled device) is adopted to be the image retrieval device and a LED is incorporated to be a light source so as to retrieve the image of the target device, that is a whole image or a part of image of the backside of the PCB board (the above-mentioned is the preceding step: retrieving an image of the target device 201). The CCD will transmit the retrieved image to the defect inspecting device, namely, the calculating device, and a specific inspecting region will be subsequently assigned from the retrieved images of the PCB board through an operating software installed in the defect inspecting device. And a defect recognizing scheme will be implemented and the parameters thereof will be simultaneously set up through the interface of the operating software (the above-mentioned is the preceding step: selecting a target device and a defect recognizing scheme by users 202). It is noted that the defect recognizing scheme refers to a algorithm used to analyze the image within a specific inspecting region. That is the defect inspecting device 10 determines whether the solders soldering within the specific inspecting region comply with the standards or not. In the present invention, the defect recognizing scheme is a Blob algorithm or a patterning matching algorithm is adopted in this embodiment; however, the defect recognizing scheme according to the present invention is not limited to the above-mentioned two ones.

First, the defect inspecting device finds out a plurality of inspecting conditions from the inspecting condition database 208 corresponding to a defect recognizing scheme which is selected by users. The plurality of inspecting conditions are parameters with respect to the defect recognizing scheme. Typically different defect recognizing scheme would correspond or adopt different inspecting conditions (parameters). Taking the Blob algorithm adopted by the present invention as example, the algorithm corresponds to a plurality of parameters such as: a binarized boundary value, a brightness contrast and an amount of inspected devices. When the training is performed, a reasonable initial value is determined in advance (the above-mentioned is the preceding step: setting a plurality of initial conditions for the defect recognizing scheme 203). At this time been, since the target device 14 is a standard DUT complying with the requirements of the quality control, a plurality of the optimized parameters is calculated by an inverse computation in accordance with the standard target device 14. The parameters obtained from the above-mentioned should be the optimum values. The above-mentioned is the training phase (the above-mentioned is the preceding step: executing the training 204).

After the training is completed, the optimized parameters would be demonstrated to users and subsequently ask the users to response whether the optimized parameters are accepted or not, for instance, to propose whether the numbers of blobs are enough or an area of blob is suitable or appropriate (the above-mentioned is the preceding step: asking the users to response the training results 205). If one is not satisfied to the training results, for instance, the training results are unsuitable or inappropriate, one is allowed to operate the interactive interface of the operation software installed on the defect inspecting device, to fine re-adjust the optimized parameters manually (the above-mentioned is the preceding step: manually adjusting the plurality of conditions 206). The interactive interface of the operation software interacts with users by using a yes/no question sentence, choice question or a simple question requesting one to input the value of parameter, for instance, to promote one to input whether the numbers of blobs are correct or not, or the area of blob is suitable or not. One could input the correct numbers of blobs needed to be inspected and directly draw a suitable size for blob. The trained conditions could become more suitable to user's expectation and the rate of inspection could be well enhanced through allowing one to enter to adjust the conditions.

Finally, the calculating device outputs all adjusted optimized parameters (the above-mentioned is the preceding step: outputting the adjusted plurality of conditions 209), and in the meantime outputs the relevant inspecting information, such as the coordinate of the specific inspecting region, the inspecting procedures, the image of the inspecting area and the other relevant data. Typically all inspecting conditions or inspecting information could be stored in the file archive or other storing media by file archives, signals, pictures or images, such that it is simply to hand over the entire inspecting information to other inspecting device so as to inspect other target device.

When the above-mentioned training phase is completed, it means that the values of the parameters would be applicable to the subsequent inspecting process are well adjusted within an acceptable scope and could be applied to the subsequent defect inspecting method to discover the nonstandard device during the coming working phase.

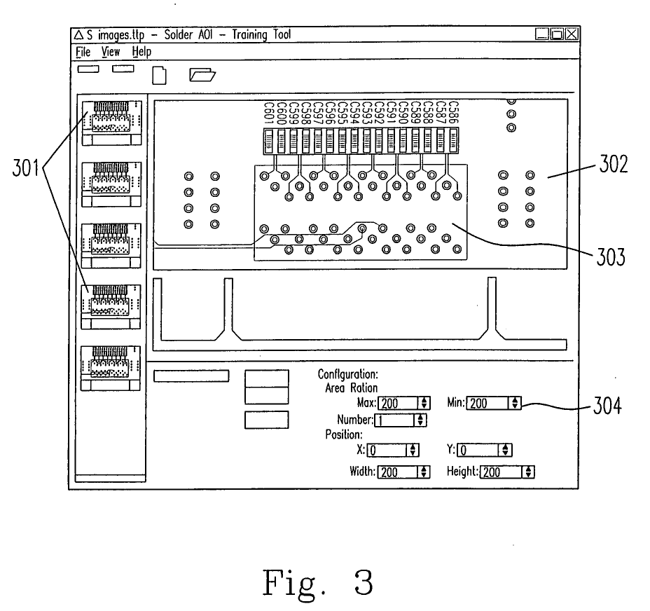

The interface of the operation software used during the training phase will be further described as follows. Please refer to FIG. 3, which is a diagram illustrating the interface of the operation software used during the training phase. The elements in the FIG. 3 include an image frame 301, an enlarged image frame 302, a specified image frame 303 and a plurality of columns for showing inspecting conditions 304, wherein the specified image frame 303 contains a image of the target device needed to be inspected. In the beginning, a whole image or a part of image of the backside of PCB board would be demonstrated in the image frame 301 and the operation software will enlarge this image and show it in the enlarged image frame 302. One could refer to the image contained in the enlarged image frame 302 to select a specified image and the specified image will be shown in the specified image frame 303. Then one uses the plurality of columns for showing inspecting conditions 304 to set up various inspecting conditions, at least including the detailed coordinate information and a specified defect recognizing scheme and parameters thereof.

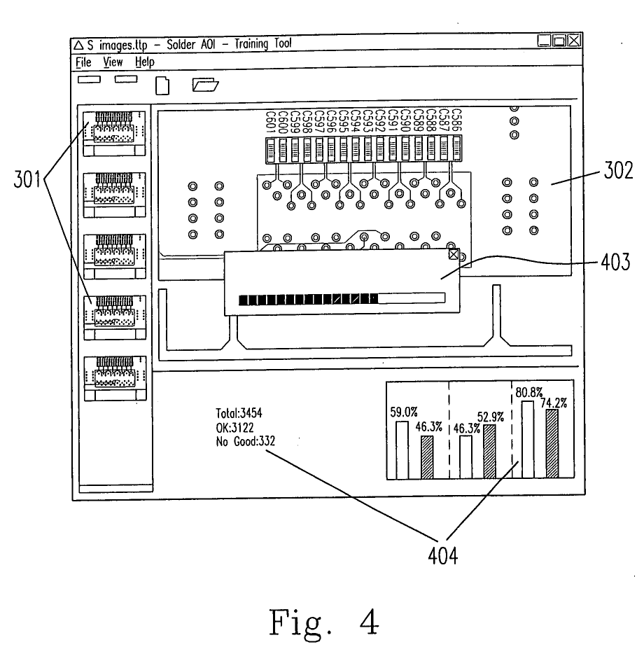

Please refer to FIG. 4, which is a diagram illustrating the interface of the operation software used during the execution of the defect recognizing scheme at the training phase. The elements in the FIG. 4 include a training (testing) display 403 and a plurality of columns for showing inspecting information 404. The training will be performed based on the image of the target device shown in the specified image frame 303. Since the target device is a standard device complying with the requirements of the quality control, the trained inspecting conditions are the optimized inspecting conditions. When the training is performed, the training display 403 would be shown on the screen by the operation software and the training results would be shown in the plurality of columns for showing inspecting information 404.

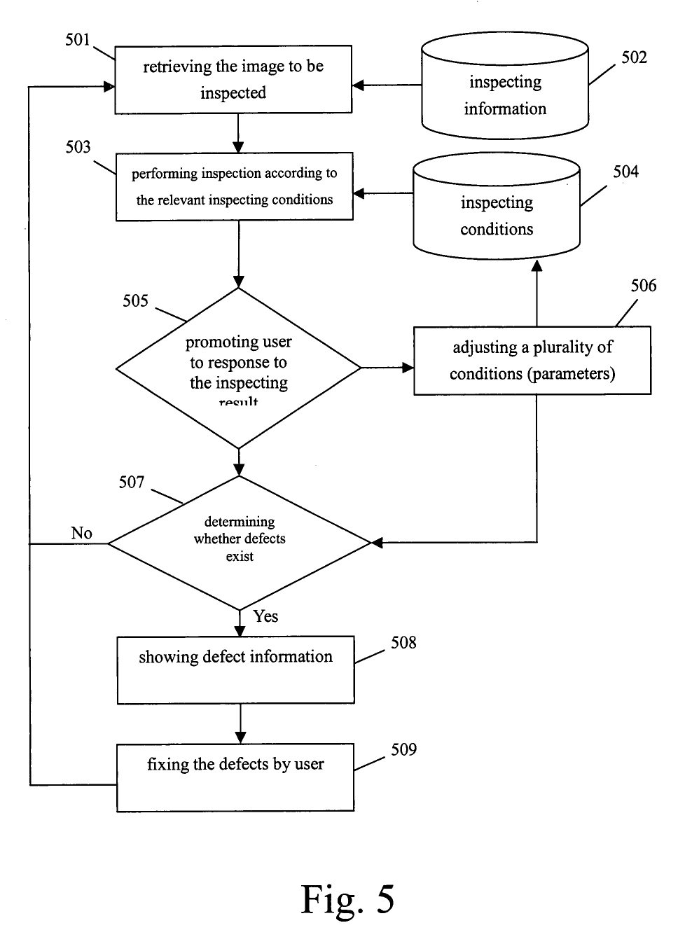

The implementation of the working phase is introduced as follows. Please refer to FIG. 5, which is a flow chart illustrating the working phase according the defect inspecting method of the present invention. The steps of the FIG. 5 includes steps of retrieving the image to be inspected 501, performing inspection according to the relevant inspecting conditions 503, promoting user to response to the inspecting result 505, adjusting a plurality of conditions (parameters) 506, determining whether defects exist 507, showing defect information 508 and fixing the defects by user 509, and in FIG. 5, it further includes inspecting information 502 and inspecting conditions 504.

While performing the working, in the beginning, the defect inspecting device automatically retrieves the coordinate of the specified image of the target device within the specified image frame 303 according to the inspecting information 502 (the above-mentioned is the preceding step: retrieving the image to be inspected 501). Then the defect inspecting device performs the inspection to the target device 14 according to the inspecting conditions 504 (the above-mentioned is the preceding step: performing inspection according to the relevant inspecting conditions 503). The above-mentioned inspecting conditions 503 refer to the optimized parameters obtained during the training phase. Once the inspection is completed, the defect inspecting device shows the defects of the target device and promotes user to response to the inspecting results (the above-mentioned is the preceding step: promoting user to response to the inspecting result 505). At the moment, if one is not satisfied to the working results, one could utilize the interactive interface installed in the operation software to response, so as to fine re-adjust the inspecting conditions (parameters) manually (the above-mentioned is the preceding step: adjusting a plurality of conditions (parameters) 506). As mentioned in the preceding descriptions with respect to training phase, one could fine re-adjust the inspecting conditions manually, such as inputting the correct numbers of blobs needed to be inspected and directly draw a suitable size for blob. The inspecting conditions could become more suitable to user's expectation and the rate of inspection could be well enhanced through allowing one to enter to adjust the conditions. As if one does not response to this step, the defect inspecting device will directly perform the determination of whether the target device exist defects based on the selected defect recognizing scheme by user (the above-mentioned is the preceding step: determining whether defects exist 507). If a defect is not found out, further inspection is performed to the rest regions of the backside of PCB board of the target device. If a defect or more defects are found out, the defect inspecting device will show the defect information, including the statistic information thereof (the above-mentioned is the preceding step: showing defect information 508). One could fix the defect(s) existing in the target device 14 in accordance with such information (the above-mentioned is the preceding step: fixing the defects by user 509).

It is noted that the defect inspecting device according to the present invention could control the image retrieval device through the operation software or the firmware to obtain a whole image or a part of image of the target device locating at a particular coordinate. There are several manners used to retrieve the image positioned at a particular coordinate including using different light source, using light with different colors or with different strength or lighting with different angles or different distances, such that the defect inspecting device could retrieve a plurality of images which is retrieved by different recognizing schemes but is exactly positioned at the same coordinate to perform a better inspection. The step showing defect information 508 could directly show the image located at the position of the defect(s) or show the coordinate thereof. The different defects could be shown in different showing manners, such as, circling the defect(s). The interactive interface of the operation software interacts with users by using a yes/no question sentence, choice question or a simple question requesting one to input the value of parameter. One could again perform the inspection after the defect(s) is fixed to determine whether the defect is actually fixed or not. The inspecting information could be stored and calculated so as to obtain a further information.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims that are to be accorded with the broadest interpretation, so as to encompass all such modifications and similar structures. According, the invention is not limited by the disclosure, but instead its scope is to be determined entirely by reference to the following claims.

What is claimed is:

1. A defect inspecting method for inspecting a defect information of a target device, comprising steps of:
retrieving one of a whole image and a part of image of the target device;
setting a plurality of conditions for a defect recognizing scheme;
adjusting the plurality of conditions by a manual scheme;
adjusting the plurality of conditions based on the retrieved image; and
implementing the defect recognizing scheme based on the adjusted plurality of conditions for inspecting the target device, so as to obtain the defect information of the target device.

2. A defect inspecting method according to claim 1, further comprising a step of:
outputting the adjusted plurality of conditions to a database.

3. A defect inspecting method according to claim 1, wherein the step of setting is accomplished by accessing the plurality of conditions from a database.

4. A defect inspecting method according to claim 1, further comprising a step of:
outputting the defect information.

5. A defect inspecting method according to claim 1, wherein the defect recognizing scheme is one of a Blob algorithm and a patterning matching algorithm.

6. A defect inspecting method according to claim 5, wherein the plurality of conditions with respect to the Blob algorithm comprise one selected from a group consisting of a binarized boundary value, a brightness contrast and an amount of inspected devices.

7. A defect inspecting method according to claim 1, wherein the plurality of conditions comprise a plurality of numerical parameters.

8. A condition adjusting method, for inspecting at least one standard device to obtain a plurality of conditions for a defect recognizing scheme, comprising steps of:
retrieving one of a whole image and a part of image of the at least one standard device;
adjusting the plurality of conditions based on the retrieved image; and
adjusting the plurality of conditions by a manual scheme.

9. A condition adjusting method according to claim 8, further comprising a step of:
outputting the adjusted plurality of conditions to a database.

10. A defect inspecting device inspecting a defect information of a target device, comprising:
a image retrieval device obtaining one of a whole image and a part of image of the target device;
a calculating device connected with the image retrieval device, for providing a defect recognizing scheme and a plurality of conditions thereof, adjusting the plurality of conditions and inspecting the target device by the defect recognizing scheme based on the plurality of conditions, so that the defect information is obtained; and
an output device connected with the calculating device, for outputting the defect information.

11. A defect inspecting device according to claim 10, wherein the plurality of conditions are adjusted by the calculating device based on a manual scheme.

12. A defect inspecting device according to claim 10, wherein the plurality of conditions are adjusted by the calculating device based on the images.

13. A defect inspecting device according to claim 10, wherein the image retrieval device is a CCD.

14. A defect inspecting device according to claim 10, wherein the calculating device is one selected from a group consisting of an inspect circuit, a personal computer and a notebook computer.

15. A defect inspecting device according to claim 10, wherein the output device is one selected from a group consisting of a CRT screen, a panel display and a projector.

16. A defect inspecting device according to claim 10, wherein the defect recognizing scheme is one of a Blob algorithm and a patterning matching algorithm.

17. A defect inspecting device according to claim 16, wherein the plurality of conditions with respect to the Blob algorithm comprise one selected from a group consisting of a binarized boundary value, a brightness contrast and an amount of inspected devices.

18. A defect inspecting device according to claim 10, wherein the plurality of conditions comprise a plurality of numerical parameters.
